(19) United States
(12) Patent Application Publication
(10) Pub. No.: US 2009/0256056 A1
(43) Pub. Date: Oct. 15, 2009

(54) DEVICE FOR MANUFACTURING LENSES

(75) Inventor: Chia-Ying Wu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/237,618

(22) Filed: Sep. 25, 2008

(30) Foreign Application Priority Data
Apr. 11, 2008 (CN) 200810301057.X

(51) Int. Cl. B29C 33/42

(52) U.S. Cl. 249/203

(57) ABSTRACT

A device for manufacturing lenses includes a tray, a cover, and a sheet. The tray defines supporting holes arranged in rows and columns. The cover defines through holes arranged in rows and columns. The sheet is positioned between the tray and the cover, and defines restricting passages. Each of the plurality of restricting passages corresponds to a column of corresponding supporting holes and a column of corresponding through holes.

### CROSS-REFERENCE STATEMENT

The present application is based on, and claims priority from, CN Application Serial Number 200810301057.X, filed on Apr. 11, 2008, titled “DEVICE FOR MANUFACTURING LENSES”, the disclosure of which is hereby incorporated by reference herein in its entirety.

### BACKGROUND

1. Technical Field

The present disclosure relates to a device for manufacturing lenses.

2. Description of Related Art

Optical lenses are used in a variety of optical products and are generally coated with film to improve optical characteristics.

In the development of optical products, elliptical and rectangular lenses are widely used. An elliptical or rectangular lens is usually supported by a rectangular substrate. In a typical coating process, a device for manufacturing lenses has many rectangular holes to receive the rectangular substrate. However, each rectangular hole must be formed having four chamfers, which complicates the structure of the device and increases cost.

Therefore, a new device for manufacturing lenses is desired to overcome the above-described shortcoming.

### SUMMARY

An embodiment of a device for manufacturing lenses includes a tray, a cover, and a sheet. The tray defines a plurality of supporting holes arranged in rows and columns. The cover defines a plurality of through holes arranged in rows and columns. The sheet is positioned between the tray and the cover, and defines a plurality of restricting passages. Each of the plurality of restricting passages corresponds to a column of corresponding supporting holes and a column of corresponding through holes.

Other advantages and novel features will become more apparent from the following detailed description when taken in conjunction with the accompanying drawings.

### BRIEF DESCRIPTION OF THE DRAWINGS

Many aspects of the device for manufacturing lenses can be better understood with reference to the following drawings. The components in the drawings are not necessarily drawn to scale, the emphasis instead being placed upon clearly illustrating the principles of the embodiment. Moreover, in the drawings, like reference numerals designate corresponding parts throughout the several views.

FIG. 1 is a perspective view of one embodiment of a device for manufacturing lenses.

FIG. 2 is an exploded view of the device of FIG. 1.

FIG. 3 is a partial cross-sectional view of the device taken along line III-III of FIG. 1.

FIG. 4 is a perspective view of an uncoated lens with a substrate.

FIG. 5 is a perspective view of the device of FIG. 1, the uncoated lens with the substrate being emplaced in the device.

FIG. 6 is a partial cross-sectional view of FIG. 5.

### DETAILED DESCRIPTION OF THE EMBODIMENT

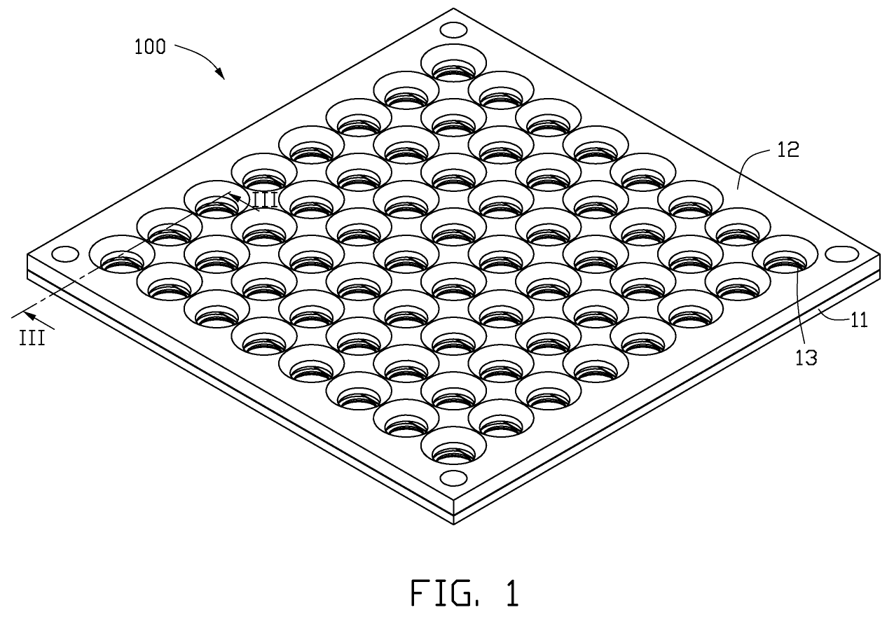

Referring to FIG. 1, one embodiment of a device 100 for manufacturing lenses includes a tray 11, a cover 12, and a sheet 13 positioned between the tray 11 and the cover 12.

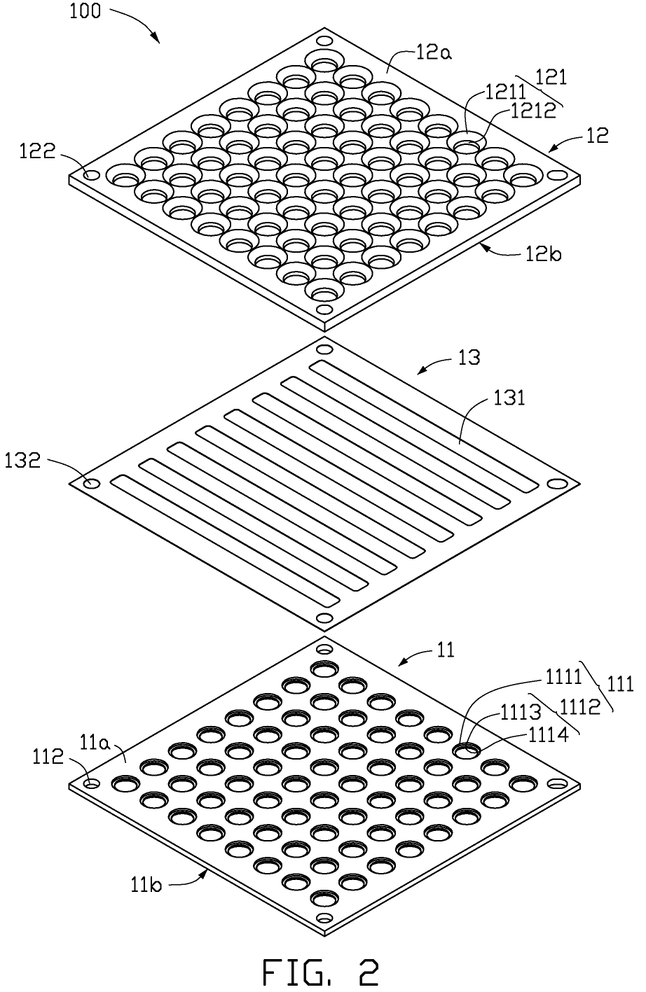

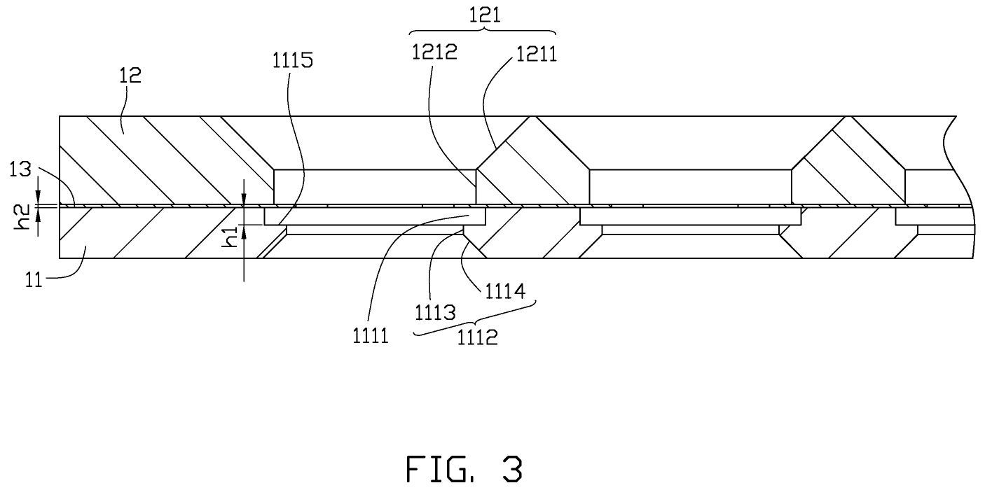

Referring to FIG. 2 and FIG. 3, the tray 11 includes a first surface 11a contacting the sheet 13 and a second surface 11b opposite to the first surface 11a. In one embodiment, the tray 11 may be rectangular shaped. A plurality of supporting holes 111 is defined in the tray 11 and arranged in rows and columns. Each of the supporting holes 111 may be a through hole and includes a circular portion 1111 and a first receiving portion 1112 communicating with the circular portion 1111. The circular portion 1111 has a thickness h1. The first receiving portion 1112 includes a circular intermediate portion 1113 and a first frustoconical portion 1114. The circular intermediate portion 1113 communicates the circular portion 1111 to the first frustoconical portion 1114. The circular intermediate portion 1113 has a diameter less than a diameter of the circular portion 1111, whereby an annular ledge 1115 is formed between the circular intermediate portion 1113 and the circular portion 1111. A minimum diameter of the first frustoconical portion 1114 is substantially equal to the diameter of the circular intermediate portion 1113. A plurality of first positioning holes 112 is defined on the tray 11. The plurality of first positioning holes 112 may be four through holes defined in four corners of the tray 11.

The cover 12 includes a first surface 12a and a second surface 12b contacting the sheet 13 and opposite to the first surface 12a. In one embodiment, the cover 12 may be rectangular shaped. A plurality of through holes 121 is defined in the cover 12 and arranged in rows and columns. Each of the through holes 121 corresponds to a corresponding supporting hole 111 and includes a second frustoconical portion 1211 and a second receiving portion 1212 communicating to the second frustoconical portion 1211. A minimum diameter of the frustoconical portion 1211 is equal to a diameter of the second receiving portion 1212. A plurality of second positioning holes 122 is defined in the cover 12 and corresponds to the first positioning holes 112. The plurality of second positioning holes 122 may be four through holes defined in four corners of the cover 12.

The sheet 13 has a thickness h2 and defines a plurality of restricting passages 131. In one embodiment, the sheet 13 may be rectangular shaped. The plurality of restricting passages 131 may be rectangular shaped and substantially parallel and substantially evenly spaced apart from each other. Each of the passages 131 corresponds to a column of corresponding supporting holes 111 and a column of corresponding through holes 121. A plurality of third positioning holes 132 is defined in the sheet 13. The plurality of third positioning holes 132 may be four through holes positioned on four corners of the sheet 13. Each of the third positioning holes 132 corresponds to a corresponding first positioning hole 112 and a corresponding second positioning hole 122.

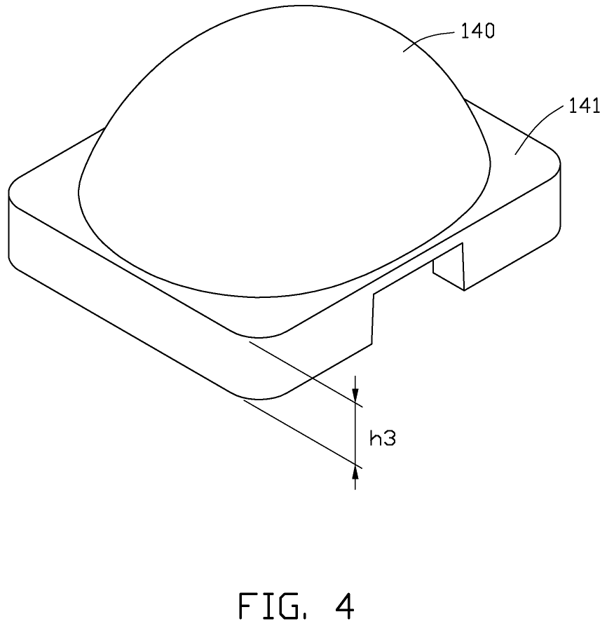

Referring to FIG. 4, an uncoated lens 140 is supported by a substrate 141 having a thickness h3. The substrate 141 may be rectangular shaped. In one embodiment, the thickness h3 is substantially equal to the sum of the thicknesses h1 and h2. A width of the substrate 141 is substantially equal to a width of each of the passages 131, and less than the diameter of the circular portion 1111, and larger than the diameter of the second receiving portion 1212.

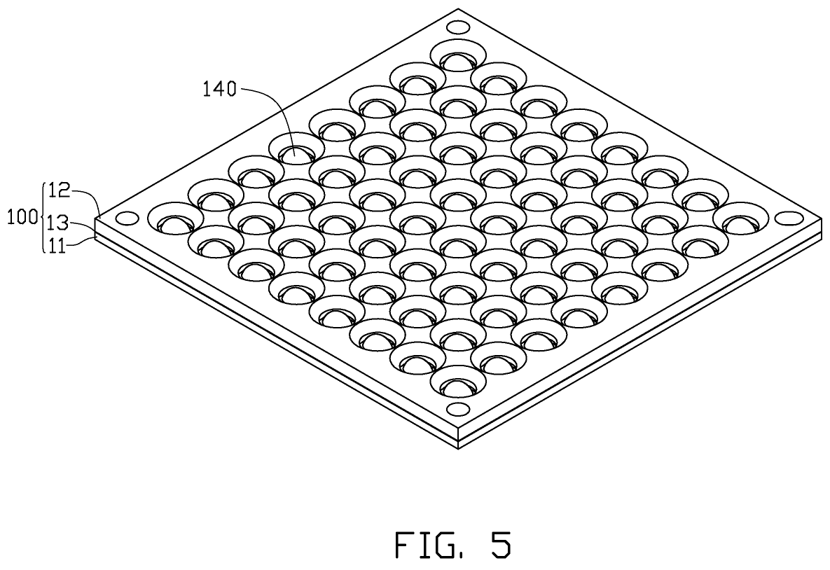

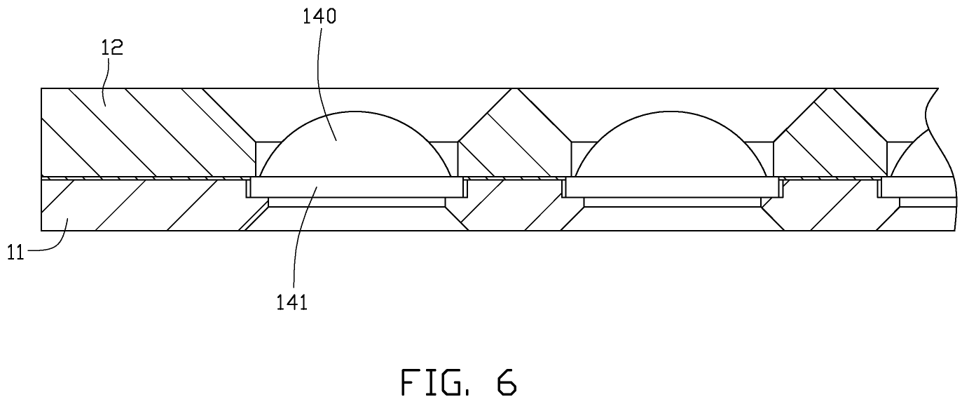

Referring to FIG. 5 and FIG. 6, to coat the uncoated lens 140, the substrate 141 is received in the circular portion 1111 and contacting the ledge 1115. The sheet 13 is positioned on the first surface 11a. The first, second, and third positioning holes 112, 122, 132 aid in aligning the tray 11, the cover 12, and the sheet 13 together. The substrate 141 is received and restricted in the passage 131. The cover 12 is positioned on the sheet 13. The second surface 12b contacts the sheet 13 and the partial substrate 141. The uncoated lens 140 passes through the second receiving portion 1212 and the second frustoconical portion 1211, and is exposed to outside via the cover 12. The lens 140 is then coated with a film by an evaporating or sputtering method.

The sheet 13 and the cover 12 restrict and fix the substrate 141 on the tray 11 during a coating process. In addition, the plurality of circular intermediate portion 1113 and the plurality of first frustoconical portion 1114 allow biconvex lenses to be coated by the device 100. Moreover, the device 100 can accommodate a lens supported by a circular substrate.

It is believed that the present embodiments and their advantages will be understood from the foregoing description, and it will be apparent that various changes may be made thereto without departing from the spirit and scope of the invention or sacrificing all of its material advantages, the examples here before described merely being preferred or exemplary embodiments of the invention.

What is claimed is:

1. A device for manufacturing lenses, comprising:
a tray defining a plurality of supporting holes arranged in rows and columns;
a cover defining a plurality of through holes arranged in rows and columns; and
a sheet positioned between the tray and the cover and defining a plurality of restricting passages, wherein each of the plurality of restricting passages corresponds to a column of corresponding supporting holes and a column of corresponding through holes.

2. The device of claim 1, wherein each of the plurality of restricting passages is rectangular shaped.

3. The device of claim 1, wherein the plurality of restricting passages is substantially parallel and substantially evenly spaced apart from each other.

4. The device of claim 1, wherein each hole of the plurality of supporting holes comprises a circular portion.

5. The device of claim 4, wherein each hole of the plurality of supporting holes further comprises a first receiving portion communicating with the circular portion.

6. The device of claim 5, wherein each of the first receiving portions comprises a circular intermediate portion and a first frustoconical portion; each of the circular intermediate portions connects a corresponding one of the circular portions to a corresponding one of the first frustoconical portions; each of the circular intermediate portions has a diameter less than a diameter of each of the circular portions such that an annular ledge is formed; a minimum diameter of each of the first frustoconical portions is substantially equal to the diameter of each of the circular intermediate portions.

7. The device of claim 4, wherein each of the plurality of through holes comprises a second frustoconical portion and a second receiving portion communicating to the second frustoconical portion; a minimum diameter of each of the second frustoconical portions is substantially equal to a diameter of each of the second receiving portions; a width of each of the restricting passages is larger than the diameter of each of the second receiving portions and less than a diameter of each of the circular portions.

8. The device of claim 1, wherein the tray defines a plurality of first positioning holes; the cover defines a plurality of second positioning holes; the sheet defines a plurality of third positioning holes; each of the plurality of third positioning holes corresponds to a corresponding one of the first positioning holes and a corresponding one of the second positioning holes; the plurality of first, second, and third positioning holes align the cover, the sheet, and the tray.

9. The device of claim 8, wherein the plurality of first, second, and third positioning holes are through holes.

10. A device for manufacturing a lens supported by a substrate, comprising:
a tray defining a plurality of supporting holes arranged in rows and columns, each of the plurality of supporting holes comprising a circular portion;
a cover defining a plurality of through holes arranged in rows and columns; and
a sheet positioned between the tray and the cover and defining a plurality of restricting passages corresponding to a column of corresponding supporting holes and a column of corresponding through holes, wherein each of the plurality of restricting passages has a width less than a diameter of the circular portion and larger than a minimum diameter of each of the plurality of through holes.

11. The device of claim 10, wherein a thickness of the substrate is substantially equal to the sum of the thicknesses of the sheet and the circular portion.

12. The device of claim 10, wherein each of the plurality of restricting passages is rectangular shaped.

13. The device of claim 10, wherein the plurality of restricting passages is substantially parallel and substantially evenly spaced apart from each other.

14. The device of claim 10, wherein each of the plurality of supporting holes further comprises a first receiving portion communicating with the circular portion.

15. The device of claim 14, wherein each of the first receiving portions comprises a circular intermediate portion and a first frustoconical portion; each of the circular intermediate portions connects a corresponding one of the circular portions to a corresponding one of the first frustoconical portions; each of the circular intermediate portions has a diameter less than a diameter of each of the circular portions such that an annular ledge is formed; a minimum diameter of each of the first frustoconical portions is equal to the diameter of each of the circular intermediate portions.

16. The device of claim 10, wherein each of the plurality of through holes comprises a second frustoconical portion and a second receiving portion communicating to the second frustoconical portion, a minimum diameter of each of the second frustoconical portions is substantially equal to a diameter of each of the second receiving portions.

17. The device of claim 10, wherein the tray defines a plurality of first positioning holes; the cover defines a plurality of second positioning holes; the sheet defines a plurality of third positioning holes; each of the plurality of third positioning holes corresponds to a corresponding one of the first positioning holes and a corresponding one of the second positioning holes; the plurality of first, second, and third positioning holes align the cover, the sheet, and the tray.

18. The device of claim 17, wherein the plurality of first, second, and third positioning holes are through holes.
